(19) United States
(12) Patent Application Publication
(10) Pub. No.: US 2023/0419978 A1
(43) Pub. Date: Dec. 28, 2023

(54) SIGNAL PROCESSING DEVICE, SIGNAL PROCESSING METHOD, AND PROGRAM

(71) Applicant: SONY GROUP CORPORATION, TOKYO (JP)

(72) Inventor: NAOYA TAKAHASHI, TOKYO (JP)

(21) Appl. No.: 18/251,248

(22) PCT Filed: Oct. 7, 2021
(86) PCT No.: PCT/JP2021/037133

§ 371 Date: May 1, 2023

(30) Foreign Application Priority Data
Nov. 9, 2020 (JP) 2020-186425

(51) Int. Cl. G10L 21/0272

(52) U.S. Cl. CPC G10L 21/0272

(57) ABSTRACT

For example, a signal processing device configured to perform appropriate sound source separation processing is provided. A signal processing device includes: a downconverter configured to apply downsampling processing to a mixed sound signal in which sound source signals included in a high-frequency component higher than a predetermined frequency are mixed; a mask generation unit configured to generate a mask on the basis of a downsampling processing result provided by the downconverter; and a mask processing unit configured to apply the mask generated by the mask generation unit to the mixed sound signal.

### TECHNICAL FIELD

The present disclosure relates to a signal processing device, a signal processing method, and a program.

### BACKGROUND ART

A sound source separation technology for extracting a signal (hereinafter, it is appropriately referred to as a sound source signal) of a sound of a target sound source from a mixed sound signal including sounds from a plurality of sound sources is known (for example, see Patent Document 1).

### CITATION LIST

### Patent Document

Patent Document 1: WO 2018/047643 A

### SUMMARY OF THE INVENTION

### Problems to be Solved by the Invention

In this field, it is desirable to perform effective sound source separation processing on a mixed sound signal including a high-frequency component higher than a predetermined frequency.

An object of the present disclosure is to provide a signal processing device, a signal processing method, and a program for performing effective sound source separation processing on a mixed sound signal including a high-frequency component higher than a predetermined frequency.

### Solution to Problems

The present disclosure is, for example, a signal processing device including:
a downconverter configured to apply downsampling processing to a mixed sound signal in which sound source signals included in a high-frequency component higher than a predetermined frequency are mixed;
a mask generation unit configured to generate a mask on the basis of a downsampling processing result provided by the downconverter; and
a mask processing unit configured to apply the mask generated by the mask generation unit to the mixed sound signal.

The present disclosure is, for example, a signal processing method including:
applying, by a downconverter, downsampling processing to a mixed sound signal in which sound source signals included in a high-frequency component higher than a predetermined frequency are mixed;
generating, by a mask generation unit, a mask on the basis of a downsampling processing result provided by the downconverter; and
applying, by a mask processing unit, the generated mask to the mixed sound signal.

The present disclosure is, for example, a program configured to cause a computer to perform a signal processing method including:
applying, by a downconverter, downsampling processing to a mixed sound signal in which sound source signals included in a high-frequency component higher than a predetermined frequency are mixed;
generating, by a mask generation unit, a mask on the basis of a downsampling processing result provided by the downconverter; and
applying, by a mask processing unit, the generated mask to the mixed sound signal.

### BRIEF DESCRIPTION OF DRAWINGS

FIG. 1 is a block diagram illustrating a configuration example of a signal processing device according to a first embodiment.

FIG. 2 is a block diagram illustrating a detailed configuration example of a mask generation unit according to the first embodiment.

FIG. 3 is a flowchart referred to when describing an operation example of the signal processing device according to the first embodiment.

FIG. 4 is a block diagram illustrating a configuration example of a signal processing device according to a second embodiment.

FIG. 5 is a block diagram illustrating a detailed configuration example of a sound source separation unit according to the second embodiment.

### MODE FOR CARRYING OUT THE INVENTION

Hereinafter, embodiments and the like of the present disclosure will be described with reference to the drawings. Note that the description will be given in the following order.
<Problems to be Considered in Embodiments>
<First Embodiment>
<Second Embodiment>
<Modification Examples>

The embodiments and the like described below are preferred specific examples of the present disclosure, and the content of the present disclosure is not limited to these embodiments and the like.

### Problems to be Considered in Embodiments

First, problems to be considered in the embodiments will be described in order to facilitate understanding of the present disclosure.

A sampling frequency of a band-limited audio signal of a telephone or the like is generally about 8 kHz, but a sampling rate such as 44.1 kHz or 48 kHz is used for a signal of music or the like requiring high sound quality. In recent years, high resolution audio (hereinafter, appropriately referred to as a high-res sound source) has become widespread for further high sound quality, and the sampling frequency is as high as 88.2 kHz to 192 kHz. That is, a mixed sound signal including a high-frequency component higher than a predetermined frequency (for example, 48 kHz) has been used.

In addition, a technology called sound source separation for separating each sound source signal from a mixed sound signal including various sound source signals is used in karaoke, remixing of sound sources, and the like. Generally, a memory and a calculation cost necessary for sound source separation are proportional to the square of a sampling frequency. In many situations including embedded systems and cloud services, while there is a strong demand for saving memory and calculation costs, there is also a demand for sound source separation with high sound quality, which is a contradictory demand.

In particular, when sound source separation is performed on a high-res sound source, there is a problem in that input data is too high in dimension and therefore a learning model for sound source separation cannot be learned by general hardware. When the model size of the learning model is reduced to a level that can be learned by general hardware, the performance of the learning model is also reduced, and the sound source separation performance is greatly reduced. This is not preferable because the separation results of the high-res sound source that should have higher sound quality than the sound source that is not the high-res sound source (a sound source in a normal band that does not include a high-frequency component higher than a predetermined frequency, and hereinafter, is appropriately referred to as a non-high-res sound source) does, is worse than that of the non-high-res sound source. In addition, even if there is learnable hardware, it is difficult to obtain a high-res stem sound source (individual sound sources before being mixed) necessary for learning sound source separation, and it is difficult to learn a high-res sound source separation model in the first place. Furthermore, even if learning can be performed, the calculation cost is too high, which is not preferable. On the basis of the above points, the present disclosure will be described in detail using the embodiments.

### First Embodiment

### [Signal Processing Device According to First Embodiment]

### Configuration Example

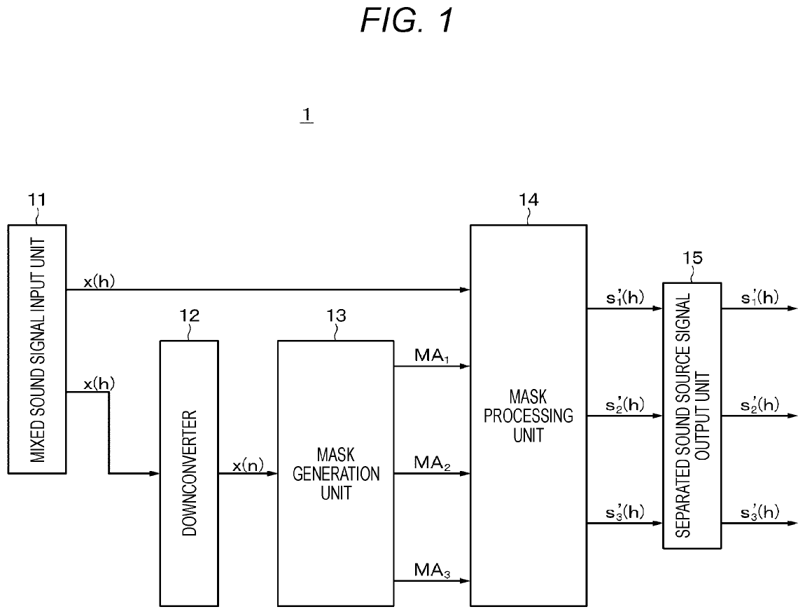

FIG. 1 is a block diagram illustrating a configuration example of a signal processing device (signal processing device 1) according to a first embodiment. The signal processing device 1 includes, for example, a mixed sound signal input unit 11, a downconverter 12, a mask generation unit 13, a mask processing unit 14, and a separated sound source signal output unit 15.

The mixed sound signal input unit 11 is an interface to which a mixed sound signal obtained by mixing a plurality of sound source signals is input. The plurality of sound source signals is sound source signals included in a high-frequency component higher than a predetermined frequency. The predetermined frequency is, for example, 48 kHz, but may be another frequency (96 kHz or the like). As described above, the mixed sound signal according to the present embodiment is a high-res sound source. Examples of the mixed sound signal input unit 11 include a drive device that reads the mixed sound signal from a medium (semiconductor memory, magnetic memory, optical memory, and the like) in which the mixed sound signal is recorded, and a communication unit that acquires the mixed sound signal via a network. A mixed sound signal x(h) input to the mixed sound signal input unit 11 is branched and supplied to each of the downconverter 12 and the mask processing unit 14. Note that, in the following description, the mixed sound signal x(h) will be described as a signal obtained by mixing sound source signals of a vocal, a drum, and a bass, as an example of sound source signals.

The downconverter 12 applies downsampling processing to the mixed sound signal x(h). The downsampling by the downconverter 12 generates a mixed sound signal x(n) which is a mixed sound signal of a non-high-res sound source. The mixed sound signal x(n) is supplied to the mask generation unit 13.

The mask generation unit 13 generates a mask on the basis of a result of the downsampling processing by the downconverter 12. For example, a mask corresponding to each sound source signal included in the mixed sound signal x(n) and separating the sound source signal is generated. In the present embodiment, the mask generation unit 13 generates a mask MA₁ corresponding to the vocal, a mask MA₂ corresponding to the drum, and a mask MA₃ corresponding to the bass. The masks generated by the mask generation unit 13 are supplied to the mask processing unit 14. Note that a detailed configuration example of the mask generation unit 13 will be described later.

The mask processing unit 14 applies the masks generated by the mask generation unit 13 to the mixed sound signal x(h). As a result, each sound source signal is separated from the mixed sound signal x(h). For example, applying the mask MA₁ to the mixed sound signal x(h) by the mask processing unit 14 separates a sound source signal s′₁(h) of the vocal from the mixed sound signal x(h). Furthermore, applying the mask MA₂ to the mixed sound signal x(h) by the mask processing unit 14 separates s′₂(h), which is a sound source signal of the drum, from the mixed sound signal x(h). Furthermore, applying the mask MA₃ to the mixed sound signal x(h) by the mask processing unit 14 separates s′₃(h), which is a sound source signal of the bass, from the mixed sound signal x(h).

The mask processing unit 14 includes a filter in which an input (in the present embodiment, the mixed sound signal x(h)) and the sum of outputs (the sum of s′₁(h), s′₂(h), and s′₃(h)) of the mask processing unit 14 matches. An example of such a filter can be a Wiener filter. In this case, a mask may also be referred to as a Wiener filter gain or the like.

The separated sound source signal output unit 15 is an interface that outputs the sound source signal s′₁(h), the sound source signal s′₂(h), and the sound source signal s′₃(h) separated by the mask processing unit 14. The sound source signals are used according to the application output from the separated sound source signal output unit 15, for example, used as object sound sources for remixing (changing volume, localization, and tone) or generating multichannel audio.

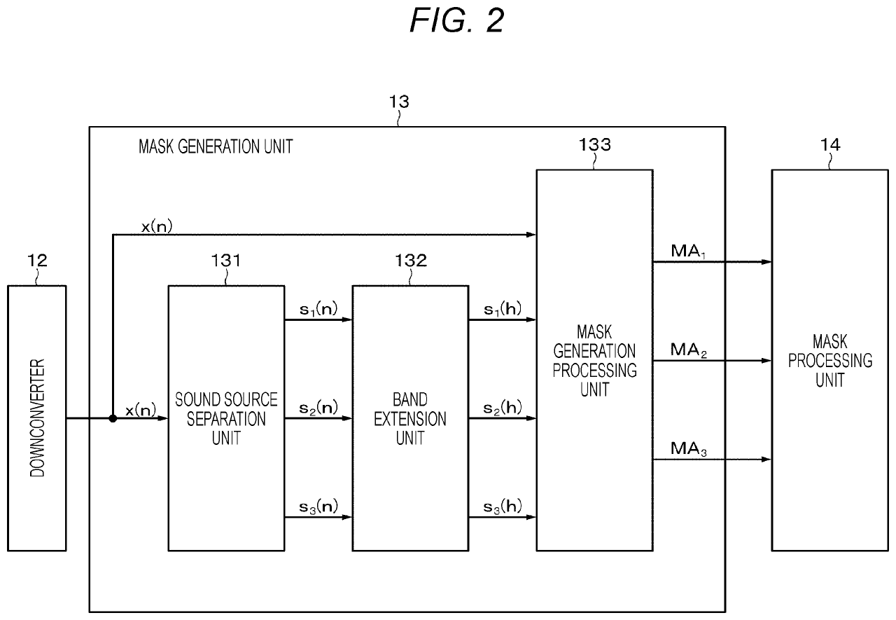

Next, a detailed configuration example of the mask generation unit 13 will be described with reference to FIG. 2. The mask generation unit 13 includes, for example, a sound source separation unit 131, a band extension unit 132, and a mask generation processing unit 133. The mixed sound signal x(n), which is a non-high-res sound source output from the downconverter 12, is output to each of the sound source separation unit 131 and the mask generation processing unit 133.

The sound source separation unit 131 performs sound source separation processing on the mixed sound signal x(n) to which the downsampling processing by the downconverter 12 has been applied. The sound source separation processing is not limited to specific processing, but for example, the sound source separation processing described in Patent Document 1 can be applied. In a case where the sound source separation is implemented by a neural network (NN), a sound source separator f( ) can be learned using a mixed sound signal x and a sound source signal si constituting the mixed sound signal x as learning data. The learning can be performed by a stochastic gradient method or the like so as to minimize an error between a separation result f(x, θ) and a correct answer sound source signal si. By the processing of the sound source separation unit 131, a sound source signal s₁(n) of the vocal, which is a non-high-res sound source, a sound source signal s₂(n) of the drum, which is a non-high-res sound source, and a sound source signal s₃(n) of the bass, which is a non-high-res sound source, are obtained. These sound source signals are supplied to the band extension unit 132.

The band extension unit 132 applies frequency band extension processing to the individual sound source signals separated by the sound source separation unit 131, and adds a high-frequency component to each of the sound source signals. The frequency band extension performed by the band extension unit 132 is not limited to specific processing, but for example, the processing described in Japanese Patent No. 6425097 proposed by the present applicant can be applied. By the frequency band extension processing by the band extension unit 132, a sound source signal s₁(h) of the vocal the band of which is extended, a sound source signal s₂(h) of the drum the band of which is extended, and a sound source signal s₃(h) of the vocal the band of which is extended, are obtained. The obtained sound source signal s₁(h), sound source signal s₂(h), and sound source signal s₃(h) are supplied to the mask generation processing unit 133.

Note that the sound source signal s₁(h), the sound source signal s₂(h), and the sound source signal s₃(h) obtained at this stage are separated signals having a band equivalent to that of a high-res sound source, but since the band extension processing is individually performed for each sound source signal, the sum of the sound source signals the bands of which are extended does not match the mixed sound signal x(h), which is the input. In addition, the high-frequency component included in the mixed sound signal x(h), which is the input high-res sound source, is completely ignored and thus the sound source signals are fabricated signals.

The mask generation processing unit 133 generates masks corresponding to respective sound source signals on the basis of at least the respective sound source signals to which the frequency band extension processing is applied. In the present embodiment, the mask generation processing unit 133 generates masks corresponding to respective sound source signals on the basis of the sound source signal s₁(h), the sound source signal s₂(h), and the sound source signal s₃(h). For example, the mask generation processing unit 133 generates the mask MA₁ on the basis of the relative ratio of the sound source signal s₁(h) to the sum of the sound source signals. The mask MA₂ and the mask MA₃ are similarly generated. The mask MA₁, the mask MA₂, and the mask MA₃ generated by the mask generation processing unit 133 are used in the mask processing unit 14. As described above, by the processing by the mask processing unit 14, the sound source signal s′₁(h), the sound source signal s′₂(h), and the sound source signal s′₃(h) are separated from the mixed sound signal x(h).

### [Flow of Processing]

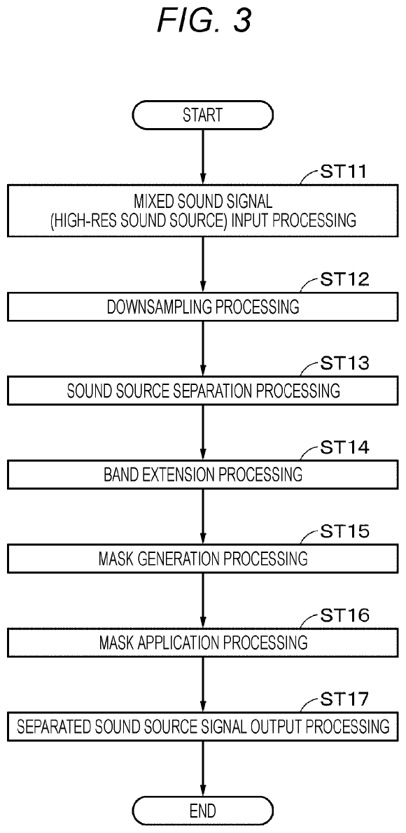

Next, an operation example of the signal processing device 1 according to the present embodiment will be described with reference to the flowchart of FIG. 3.

When the processing starts, in step ST11, processing of inputting a mixed sound signal, which is a high-res sound source, is performed. For example, the mixed sound signal x(h), which is a high-res sound source, is input to the mixed sound signal input unit 11. Then, the processing proceeds to step ST12.

In step ST12, the downsampling processing is performed. Specifically, the downconverter 12 performs the downsampling processing on the mixed sound signal x(h) input to the mixed sound signal input unit 11. Such processing generates the mixed sound signal x(n), which is a non-high-res sound source. Then, the processing proceeds to step ST13.

In step ST13, the sound source separation processing is performed. Specifically, by the sound source separation processing on the mixed sound signal x(n) by the sound source separation unit 131, the sound source signal s₁(n), the sound source signal s₂(n), and the sound source signal s₃(n) are obtained. Then, the processing proceeds to step ST14.

In step ST14, the band extension processing is performed. Specifically, the band extension unit 132 performs the band extension processing on each sound source signal obtained by the sound source separation processing by the sound source separation unit 131. As a result, the sound source signal s₁(h), the sound source signal s₂(h), and the sound source signal s₃(h) are obtained. Then, the processing proceeds to step ST15.

In step ST15, mask generation processing is performed. Specifically, the mask generation processing unit 133 generates the mask MA₁, the mask MA₂, and the mask MA₃ on the basis of the sound source signal s₁(h), the sound source signal s₂(h), and the sound source signal s₃(h), respectively. Then, the processing proceeds to step ST16.

In step ST16, mask application processing is performed. Specifically, the mask processing unit 14 applies the mask MA₁, the mask MA₂, and the mask MA₃ to the mixed sound signal x(h) to separate the sound source signal s′₁(h), the sound source signal s′₂(h), and the sound source signal s′₃(h), respectively, from the mixed sound signal x(h). Then, the processing proceeds to step ST17.

In step ST17, separated sound source signal output processing is performed. Specifically, the sound source signal s′₁(h), the sound source signal s′₂(h), and the sound source signal s′₃(h) separated by the mask processing unit 14 are output from the separated sound source signal output unit 15.

### [Effects Obtained by the Present Embodiment]

According to the present embodiment, for example, the following effects can be obtained.

It is possible to perform appropriate sound source separation on a mixed sound signal, which is a high-res sound source. For example, since a high-frequency component is calculated on the basis of the input high-res sound source by mask processing, it is possible to obtain a sound source separation result in which the high-frequency component of the original high-res sound source is retained. Sound source signals separated in this way have a preferable result in content such as music, which emphasizes the creator's intention.

Generally in the sound source separation, even if there is an error in separation results and noise is conspicuous when a sound source is heard alone, in a case where the sum of the separation results matches the original sound, it is known that the noise is hardly perceived in a situation where all the separated sound sources are simultaneously played by changing spatial arrangement or volume balance such as upmixing or remixing. According to the present embodiment, it is possible to ensure that the sum of the sound source separation results obtained by the mask processing unit 14 matches the original sound (mixed sound signal, which is a high-res sound source). Therefore, even if noise is included in the sound source separation results, it is possible to obtain sound source separation results that can make it difficult for the noise to be perceived by changing the spatial arrangement or the sound volume balance.

Since the bandwidth extension processing by the band extension unit 132 in the above-described embodiment has a much smaller processing amount and required memory than the sound source separation processing does, the processing amount and the required memory can be greatly reduced as compared with the case where the sound source separation is performed in the band of the high-res sound source. In addition, it is preferable that the sound source separation results in the normal band and the separation results of the high-res sound source are substantially the same in the normal band. However, according to the present embodiment, the downsampling processing is performed even in a case where an input is a high-res sound source, and the same sound source separation processing (sound source separation processing for a sound source in the normal band) is also applied to the sound source in the normal band obtained as a result. As a result, there is no difference in sound quality and separation accuracy of the separated sound sources in the normal band, and it is possible to avoid deterioration in sound quality or deterioration in separation performance even though the sound source is a high-res sound source. In addition, it is not necessary to hold parameters of another sound source separation model for a high-res sound source, and it is possible to suppress an increase in the required number of memories and memory capacity.

### Second Embodiment

Next, a second embodiment of the present disclosure will be described. Note that the matters described in the first embodiment can also be applied to the second embodiment unless otherwise specified. Schematically, in the first embodiment, each processing is performed on a signal in the time domain, but in the second embodiment, a part of the processing described in the first embodiment is performed on a signal converted into the frequency domain, which is different from the first embodiment.

### Configuration Example

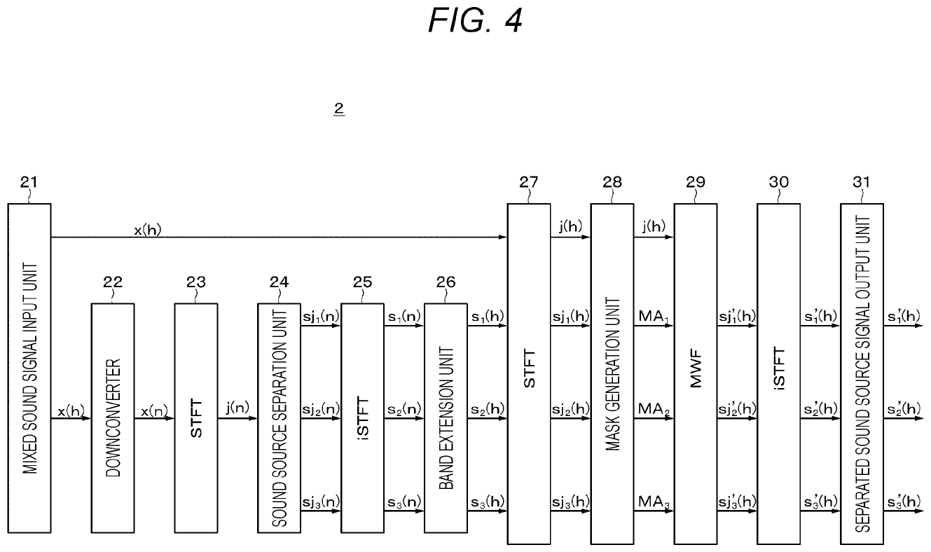

FIG. 4 is a block diagram illustrating a configuration example of a signal processing device (signal processing device 2) according to the second embodiment. The signal processing device 2 includes a mixed sound signal input unit 21, a downconverter 22, a short-term Fourier transform (STFT) 23, a sound source separation unit 24, an inverse short-term Fourier transform (iSTFT) 25, a band extension unit 26, an SIFT 27, a mask generation unit 28, a multichannel Wiener filter (MWF) 29 that is a mask processing unit in the present embodiment, an iSTFT 30, and a separated sound source signal output unit 31.

The mixed sound signal input unit 21 has a similar configuration to the mixed sound signal input unit 11. A mixed sound signal, which is a high-res sound source, is input to the mixed sound signal input unit 21.

The downconverter 22 performs the downsampling processing on the mixed sound signal similarly to the downconverter 12.

The STFT 23 converts the output signal of the downconverter 22 from a signal in the time domain into a signal in the frequency domain by performing short-time Fourier transform processing.

The sound source separation unit 24 performs the sound source separation processing on the output signal of the STFT 23. An example of the sound source separation processing performed by the sound source separation unit 24 will be described later.

The iSTFT 25 converts the output signals of the sound source separation unit 24 from signals in the frequency domain into signals in the time domain by performing short-time Fourier inverse transform.

Similarly to the band extension unit 132, the band extension unit 26 performs the band extension processing on the output signals of the iSTFT 25.

The STFT 27 performs short-time Fourier transform to convert the mixed sound signal input to the mixed sound signal input unit 21 and the output signals of the band extension unit 26 from signals in the time domain to signals in the frequency domain.

The mask generation unit 28 generates masks using the mixed sound signal and the like converted into signals in the frequency domain by the SIFT 27.

The MWF 29 applies the masks generated by the mask generation unit 28 to the mixed sound signal to separate the sound source signals included in the mixed sound signal.

The iSTFT 30 converts the separation results of the MWF 29 from signals in the frequency domain to signals in the time domain by performing short time Fourier inverse transform.

The separated sound source signal output unit 31 outputs the sound source signals converted into the signals in the time domain by the iSTFT 30.

### Operation Example

An operation example of the signal processing device 2 will be specifically described. A mixed sound signal x(h), which is a high-res sound source, is input to the mixed sound signal input unit 21. The mixed sound signal x(h) is supplied to each of the downconverter 22 and the STFT 27. The mixed sound signal x(h) is converted into a mixed sound signal x(n) by the downsampling processing of the downconverter 22.

By the short-time Fourier transform processing of the STFT 23, the mixed sound signal x(n) is converted into a mixed sound signal j(n), which is a signal in the frequency domain. Then, by the sound source separation processing of the sound source separation unit 24, a sound source signal sj₁(n) of the vocal, a sound source signal sj₂(n) of the drum, and a sound source signal sj₃(n) of the bass included in the mixed sound signal j(n) are separated.

By the subsequent short-time Fourier inverse transform of the iSTFT 25, the sound source signal sj₁(n), the sound source signal sj₂(n), and the sound source signal sj₃(n) are converted into a sound source signal s₁(n), a sound source signal s₂(n), and a sound source signal s₃(n), which are signals in the time domain.

By performing the band extension processing of the band extension unit 26 on the sound source signals converted into the signals in the time domain, the sound source signal s₁(h), the sound source signal s₂(h), and the sound source signal s₃(h) having a band equivalent to that of the high-res sound source are obtained.

By the short-time Fourier transform of the SIFT 27, the mixed sound signal x(h) is converted into a mixed sound signal j(h), which is a signal in the frequency domain. In addition, the sound source signal s₁(h), the sound source signal s₂(h), and the sound source signal s₃(h) are converted into a sound source signal sj₁(h), a sound source signal sj₂(h), and a sound source signal sj₃(h), respectively, which are signals in the frequency domain.

The mask generation unit 28 generates masks corresponding to respective sound source signals using the mixed sound signal j(h), the sound source signal sj₁(h), the sound source signal sj₂(h), and the sound source signal sj₃(h). For example, a mask is generated using a ratio to the sum of power spectra of the sound source signals. Note that the mixed sound signal j(h) is used to generate a mask in the present example. As a result, the phase component included in the original signal can be retained. Note that, in generating the mask, the phase component may be restored and adjusted in the subsequent processing without using the mixed sound signal j(h). A mask MA₁, a mask MA₂, and a mask MA₃ are generated by the mask generation unit 28. The generated masks are supplied to the MWF 29.

The MWF 29 separates a sound source signal s′j₁(h) of the vocal from the mixed sound signal j(h), for example, by applying the mask MA₁ to the mixed sound signal j(h). In addition, the MWF 29 separates a sound source signal s′j₂(h) of the drum from the mixed sound signal j(h), for example, by applying the mask MA 2 to the mixed sound signal j(h). Furthermore, the MWF 29 separates a sound source signal s′j₃(h) of the bass from the mixed sound signal j(h), for example, by applying the mask MA₃ to the mixed sound signal j(h).

Then, by the short-time Fourier inverse transform of the iSTFT 30, the sound source signal s′j₁(h), the sound source signal s′j₂(h), and the sound source signal s′j₃(h) are converted into a sound source signal s′₁(h), a sound source signal s′₂(h), and a sound source signal s′₃(h), respectively, which are signals in the time domain. The converted signals are output from the separated sound source signal output unit 31.

### Operation Example of Sound Source Separation Unit

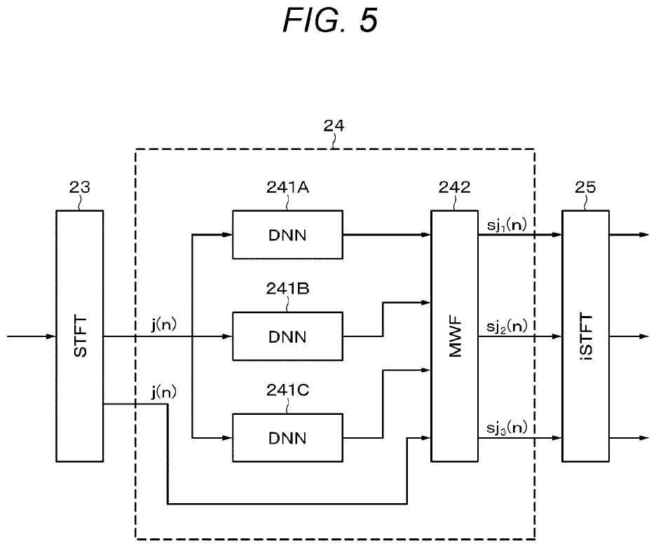

FIG. 5 is a diagram illustrating a detailed configuration example of the sound source separation unit 24. The sound source separation unit 24 includes a deep neural network (DNN) 241A, a DNN 241B, a DNN 241C, and a MWF 242. Hereinafter, a DNN- and MWF-based sound source separation method performed by the sound source separation unit 24 having such a configuration will be described. Note that, in the following description, signals are expressed in the STFT domain.

In a case where a mixed sound signal of an I channel is represented as

x(k,m)∈ [symbol] ^{I}
where k is a frequency bin and m is a frame, and
a jth source signal is represented as

sⱼ(k,m)∈ [symbol] ^{I}
then the MWF assumes a signal model as in the following equation (1):

$$x ( k , m ) = {s}_{j} ( k , m ) + z ( k , m ) = {s}_{j} ( k , m ) + {\sum }_{{j}^{′} = 1 , {j}^{′} \neq j}^{J} {s}_{{j}^{′}} ( k , m ) , {s}_{j} ( k , m ) ∼ {N}_{c} ( 0 , {v}_{j} ( k , m ) {R}_{j} ( k , m ) ) for j = 1 , … , j \qquad ( 1 )$$

where in equation (1),

vⱼ(k,m)∈ [symbol]
is power spectrum density, and

Rⱼ(k,m)
is a spatial correlation matrix.

From equation (1), it is revealed that a mixed sound signal can be represented as:

z(k,m)
that is, the sum of the jth source signal and the complex Gaussian noise. Furthermore, by assuming that the source signals are independent of each other,

sⱼ(k,m)
can be estimated from

x(k,m)
by the least mean square error method. The estimated value

ŝ_{j,MWF}(k,m)∈ [symbol] ^{I}

of the least mean square error can be determined as follows:

ŝ_{j,MWF}(k,m)=vⱼ(k,m)Rⱼ(k,m)(Σ_{j′=1}^{J}v_{j′}(k,m)R_{j′}(k,m))⁻¹x(k,m). (2)

In order to determine the source signal by equation (2),

vⱼ(k,m)

and

Rⱼ(k)
need to be determined.

In Patent Document 1, it is assumed that a spatial correlation matrix is time-invariant (a sound source position does not change), and the above terms are determined by a DNN. In a case where the output of the DNN is represented as

{ŝ₁(k,m), . . . ,ŝ_{J}(k,m)}

both

vⱼ(k,m)

and

Rⱼ(k)
are determined by the following equations (3) and (4).

$${\hat{v}}_{j} ( k , m ) = \frac{1}{I} {‖ {\hat{s}}_{j} ( k , m ) ‖}^{2} \qquad ( 3 )$$

$${\hat{R}}_{j} ( k ) = \frac{{\sum }_{m = 1}^{M} {\hat{s}}_{j} ( k , m ) {{\hat{s}}_{j} ( k , m )}^{H}}{{\sum }_{m = 1}^{M} {\hat{v}}_{j} ( k , m )} . \qquad ( 4 )$$

Note that the above-described equation (2) can be expressed as follows using a mixed sound signal:

ŝ_{j,MWF}(k,m)=vⱼ(k,m)Rⱼ(k,m)(vₓ(k,m)Rₓ(k,m))⁻¹x(k,m). (2)

In this case,

vₓ(k,m)

and

Rₓ(k)
are determined by the following equations (5) and (6):

$${v}_{x} ( k , m ) = \frac{1}{I} {‖ x ( k , m ) ‖}^{2} \qquad ( 5 )$$

$${R}_{x} ( k ) = \frac{{\sum }_{m = 1}^{M} x ( k , m ) {x ( k , m )}^{H}}{{\sum }_{m = 1}^{M} {v}_{x} ( k , m )} . \qquad ( 6 )$$

According to the present embodiment described above, similar effects to those of the first embodiment can be obtained.

### Modification Examples

Although the plurality of embodiments of the present disclosure has been described above, the present disclosure is not limited to the above-described embodiments, and various modifications can be made without departing from the gist of the present disclosure.

In the above-described embodiments, a unit other than the Wiener filter may be used as the mask processing unit. For example, a complex ratio mask described in Donald S. Williamson, et al. “Complex Ratio Masking for Monaural Speech Separation”, IEEE Trans. ASLP, 2016, Vol 24, No3 can be applied as the mask processing unit. In addition, the mask applied to the Wiener filter may be generated by other known methods.

In the above-described embodiments, the band extension processing may individually perform predetermined band extension processing on individual sound source signals, or may perform the band extension processing on a predetermined sound source signal with reference to another sound source signal. In the latter case, it is not necessary to provide a band extension unit for each sound source signal.

In the above-described second embodiment, configurations according to the STFT 27 and the iSTFT 30 do not need to be present. Then, the processing subsequent to the band extension unit 26 may be performed using signals in the time domain. As described above, the configuration and the like of the device can be appropriately changed without departing from the gist of the present disclosure.

The present disclosure can also adopt a configuration of cloud computing in which one function is shared and processed in cooperation by a plurality of devices via a network.

Furthermore, the present disclosure can also be implemented in any form such as a device, a method, a program, and a system. For example, a program that performs the functions described in the above-described embodiments can be downloaded, and a device that does not have the functions described in the embodiments downloads and installs the program, whereby the control described in the embodiments can be performed in the device. The present disclosure can also be implemented by a server that distributes such a program. In addition, the matters described in each embodiment and modification example can be appropriately combined. Furthermore, the contents of the present disclosure are not to be construed as being limited by the effects exemplified in the present specification.

The present disclosure can also have the following configurations.

(1)

A signal processing device including:
a downconverter configured to apply downsampling processing to a mixed sound signal in which sound source signals included in a high-frequency component higher than a predetermined frequency are mixed;
a mask generation unit configured to generate a mask on the basis of a downsampling processing result provided by the downconverter; and
a mask processing unit configured to apply the mask generated by the mask generation unit to the mixed sound signal.
   (2)

The signal processing device according to (1), in which the mask generation unit includes:
a sound source separation unit configured to perform sound source separation processing on the mixed sound signal to which the downsampling processing is applied;
a band extension unit configured to apply frequency band extension processing to the individual sound source signals separated by the sound source separation unit; and
a mask generation processing unit configured to generate the mask corresponding to each of the sound source signals on the basis of at least the individual sound source signals to which the frequency band extension processing is applied.
   (3)

The signal processing device according to (2), in which
the mask generation processing unit further generates the mask using the mixed sound signal.
   (4)

The signal processing device according to any one of (1) to (3), in which
the mask processing unit includes a filter in which an input and a sum of outputs of the mask processing unit matches.
   (5)

The signal processing device according to (4), in which the mask processing unit includes a Wiener filter.

(6)

The signal processing device according to any one of (1) to (5), in which
the mask processing unit separates and outputs sound source signals included in the mixed sound signal.
   (7)

The signal processing device according to (2) or (3), in which
the band extension unit applies the frequency band extension processing to each of sound source signals.
   (8)

The signal processing device according to (2) or (3), in which
the band extension unit applies the frequency band extension processing to a predetermined sound source signal with reference to another sound source signal.
   (9)

A signal processing method including:
applying, by a downconverter, downsampling processing to a mixed sound signal in which sound source signals included in a high-frequency component higher than a predetermined frequency are mixed;
generating, by a mask generation unit, a mask on the basis of a downsampling processing result provided by the downconverter; and
applying, by a mask processing unit, the generated mask to the mixed sound signal.
   (10)

A program configured to cause a computer to perform a signal processing method including:
applying, by a downconverter, downsampling processing to a mixed sound signal in which sound source signals included in a high-frequency component higher than a predetermined frequency are mixed;
generating, by a mask generation unit, a mask on the basis of a downsampling processing result provided by the downconverter; and
applying, by a mask processing unit, the generated mask to the mixed sound signal.

### REFERENCE SIGNS LIST

1, 2 Signal processing device
12, 22 Downconverter
13, 28 Mask generation unit
14 Mask processing unit
24 Sound source separation unit
29 MWF
131 Sound source separation unit
26, 132 Band extension unit
133 Mask generation processing unit

1. A signal processing device comprising:
a downconverter configured to apply downsampling processing to a mixed sound signal in which sound source signals included in a high-frequency component higher than a predetermined frequency are mixed;
a mask generation unit configured to generate a mask on a basis of a downsampling processing result provided by the downconverter; and
a mask processing unit configured to apply the mask generated by the mask generation unit to the mixed sound signal.

2. The signal processing device according to claim 1, wherein
the mask generation unit includes:
a sound source separation unit configured to perform sound source separation processing on the mixed sound signal to which the downsampling processing is applied;
a band extension unit configured to apply frequency band extension processing to the individual sound source signals separated by the sound source separation unit; and
a mask generation processing unit configured to generate the mask corresponding to each of the sound source signals on a basis of at least the individual sound source signals to which the frequency band extension processing is applied.

3. The signal processing device according to claim 2, wherein
the mask generation processing unit further generates the mask using the mixed sound signal.

4. The signal processing device according to claim 1, wherein
the mask processing unit includes a filter in which an input and a sum of outputs of the mask processing unit matches.

5. The signal processing device according to claim 4, wherein
the mask processing unit includes a Wiener filter.

6. The signal processing device according to claim 1, wherein
the mask processing unit separates and outputs sound source signals included in the mixed sound signal.

7. The signal processing device according to claim 2, wherein
the band extension unit applies the frequency band extension processing to each of sound source signals.

8. The signal processing device according to claim 2, wherein
the band extension unit applies the frequency band extension processing to a predetermined sound source signal with reference to another sound source signal.

9. A signal processing method comprising:
applying, by a downconverter, downsampling processing to a mixed sound signal in which sound source signals included in a high-frequency component higher than a predetermined frequency are mixed;
generating, by a mask generation unit, a mask on a basis of a downsampling processing result provided by the downconverter; and
applying, by a mask processing unit, the generated mask to the mixed sound signal.

10. A program configured to cause a computer to perform a signal processing method comprising:
applying, by a downconverter, downsampling processing to a mixed sound signal in which sound source signals included in a high-frequency component higher than a predetermined frequency are mixed;
generating, by a mask generation unit, a mask on a basis of a downsampling processing result provided by the downconverter; and
applying, by a mask processing unit, the generated mask to the mixed sound signal.
